(19) United States
(12) Patent Application Publication
(10) Pub. No.: US 2018/0135715 A1
(43) Pub. Date: May 17, 2018

(54) STABILIZER BUSH

(71) Applicant: TOYO TIRE & RUBBER CO., LTD., Itami-shi (JP)

(72) Inventor: Tatsuya Oniwa, Itami-shi (JP)

(73) Assignee: TOYO TIRE & RUBBER CO., LTD., Itami-shi (JP)

(21) Appl. No.: 15/723,603

(22) Filed: Oct. 3, 2017

(30) Foreign Application Priority Data
Nov. 15, 2016 (JP) 2016-222148

(51) Int. Cl. F16F 1/371; B60G 21/055; F16F 1/373

(52) U.S. Cl. CPC F16F 1/371; B60G 2204/41; F16F 1/3735; B60G 21/0551

(57) ABSTRACT

To provide a stabilizer bush capable of providing improved durability. The stabilizer bush is configured so that a pair of semi-cylindrical rubber elastic bodies are disposed on the outer periphery of a stabilizer bar. The stabilizer bar adheres to the inner surfaces of the elastic bodies. A first end portion and a second end portion of a reinforcing plate are disposed circumferentially inward from the circumferential end faces of the elastic bodies, and an intermediate portion of the reinforcing plate is connected to the first end portion and to the second end portion. The radial thickness of the elastic bodies measured between the first end portion and the inner surfaces and the radial thickness of the elastic bodies measured between the second end portion and the inner surfaces are smaller than the radial thickness of the elastic bodies measured between the intermediate portion and the inner surfaces.

### TECHNICAL FIELD

The present invention relates to a stabilizer bush, and more particularly, to a stabilizer bush that adheres to a stabilizer bar.

### BACKGROUND ART

A stabilizer is an auxiliary spring (torsion-bar spring) that acts on a main spring unbalanced by a vehicle body roll in such a manner as to offset a right-left stroke difference. A stabilizer bush works so that a stabilizer bar (torsion bar) is elastically supported on a vehicle body. The stabilizer bar is coupled at both ends to right and left links of a suspension. The stabilizer bush includes a pair of semi-cylindrical rubber elastic bodies and a bracket (Patent Literature 1). The pair of elastic bodies adhere to the outer periphery of the stabilizer bar. The bracket fastens the pair of elastic bodies to the vehicle body. A reinforcing plate is embedded in each of the elastic bodies. The pair of elastic bodies are disposed on the outer periphery of the stabilizer bar while the circumferential end faces of the elastic bodies are abutted on each other. Further, the pair of elastic bodies are pressurized from the outside in the radial direction so that the inner surfaces of the elastic bodies adhere to the stabilizer bar.

### CITATION LIST

### Patent Literature

[Patent Literature 1] JP-A No. 2010-58564

### SUMMARY OF INVENTION

### Technical Problem

However, when the above-described conventional technology is applied to let the elastic bodies adhere to the stabilizer bar, a large portion where low pressure is received from the stabilizer bar exists in the vicinity of the end faces of the elastic bodies. Such a large portion has lower adhesion strength than the other portion. The portion having relatively low adhesion strength has low durability because it is likely to peel off due to repeated load input from the stabilizer bar to the elastic bodies.

The present invention has been made to address the above problem. An object of the present invention is to provide a stabilizer bush that is capable of improving the durability.

### Solution to Problem

In order to accomplish the above object, a stabilizer bush according to the present invention is configured so that a pair of semi-cylindrical rubber elastic bodies are disposed on the outer periphery of a stabilizer bar while the two circumferential end faces of the elastic bodies are abutted on each other. The stabilizer bar adheres to the inner surfaces of the elastic bodies. A reinforcing plate having a higher rigidity than the elastic bodies is embedded in each of the elastic bodies. A first end portion and a second end portion are disposed circumferentially inward from the circumferential end faces of the elastic bodies. An intermediate portion is connected to the first end portion and to the second end portion. The radial thickness of the elastic bodies measured between the first end portion and the inner surfaces and the radial thickness of the elastic bodies measured between the second end portion and the inner surfaces are smaller than the radial thickness of the elastic bodies measured between the intermediate portion and the inner surfaces.

### Advantageous Effects of Invention

According to the stabilizer bush described in a first aspect of the present invention, the radial thickness of the elastic bodies measured between the first end portion of the reinforcing plate and the inner surfaces of the elastic bodies and the radial thickness of the elastic bodies measured between the second end portion of the reinforcing plate and the inner surfaces of the elastic bodies are smaller than the radial thickness of the elastic bodies measured between the intermediate portion of the reinforcing plate and the inner surfaces of the elastic bodies. Therefore, the elastic bodies, which are pressurized from the outside in the radial direction for adhesion purposes and pressed against the stabilizer bar, is capable of decreasing a difference between the pressure applied from the stabilizer bar to the vicinity of the first and second end portions of the reinforcing plate and the pressure applied from the stabilizer bar to the vicinity of the intermediate portion of the reinforcing plate. This makes it possible to reduce the area of a low-pressure portion existing in the vicinity of the end faces of the elastic bodies. Therefore, the area of a portion having low adhesion strength can be reduced. Consequently, the elastic bodies adhering to the stabilizer bar are unlikely to peel off. As a result, the durability of the stabilizer bush can be improved.

According to the stabilizer bush described in a second aspect of the present invention, the reinforcing plate is formed into a semi-cylindrical shape, and configured so that the inner surfaces of the first and second end portions have a smaller curvature than the inner surface of the intermediate portion. Therefore, in addition to the advantageous effect of the first aspect, the reinforcing plate can easily be formed by bending a plate material.

According to the stabilizer bush described in a third aspect of the present invention, the reinforcing plate formed into a semi-cylindrical shape is configured so that a hole is formed in the radial direction at least through the circumferential center of the elastic bodies. Pressure applied to the circumferential center of the elastic bodies (the pressure received from the stabilizer bar for adhesion purposes) is lower than when no such hole is formed. This decreases the difference between the pressure applied from the stabilizer bar to the circumferential center of the elastic bodies and the pressure applied from the stabilizer bar to the vicinity of the circumferential end faces of the elastic bodies. This reduces circumferential pressure variations when the elastic bodies are pressurized for adhesion purposes. Therefore, in addition to the advantageous effect of the first aspect, adhesion strength variations in the circumferential direction of the elastic bodies can be suppressed.

According to the stabilizer bush described in a fourth aspect of the present invention, the intermediate portion is configured so that a first portion is connected to the first end portion, and that a second portion is connected to the second end portion. The first portion and the second portion are spaced circumferentially apart from each other and disposed except at the circumferential center of the elastic bodies. Pressure applied to the circumferential center of the elastic bodies (the pressure received from the stabilizer bar for adhesion purposes) is lower than when the first and second portions are not spaced circumferentially apart from each other. This decreases the difference between the pressure applied from the stabilizer bar to the circumferential center of the elastic bodies and the pressure applied from the stabilizer bar to the vicinity of the circumferential end faces of the elastic bodies. This reduces circumferential pressure variations when the elastic bodies are pressurized for adhesion purposes. Therefore, in addition to the advantageous effect of the first aspect, adhesion strength variations in the circumferential direction of the elastic bodies can be suppressed.

### BRIEF DESCRIPTION OF DRAWINGS

FIG. 1 is an exploded view of a stabilizer bush according to a first embodiment of the present invention.

FIG. 2 is a front view illustrating a first elastic body and a second elastic body.

FIG. 3A is a plan view of a reinforcing plate, and FIG. 3B is a cross-sectional view of the reinforcing plate taken along line IIIb-IIIb of FIG. 3A.

FIG. 4A is a schematic diagram illustrating the pressure distribution of the stabilizer bush, and FIG. 4B is a schematic diagram illustrating the pressure distribution of the stabilizer bush in a comparative example.

FIG. 5 is a front view illustrating the first and second elastic bodies of the stabilizer bush according to a second embodiment of the present invention.

FIG. 6A is a plan view of the reinforcing plate, and FIG. 6B is a cross-sectional view of the reinforcing plate taken along line VIb-VIb of FIG. 6A.

FIG. 7 is a front view illustrating the first and second elastic bodies of the stabilizer bush according to a third embodiment of the present invention.

FIG. 8A is a plan view of the reinforcing plate, and FIG. 8B is a cross-sectional view of the reinforcing plate taken along line VIIIb-VIIIb of FIG. 8A.

### DESCRIPTION OF EMBODIMENTS

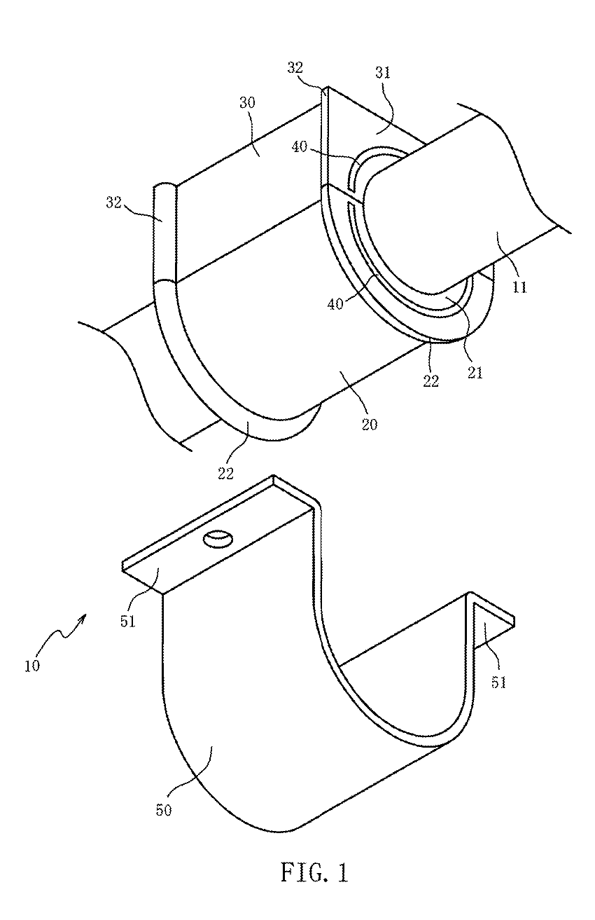

Preferred embodiments of the present invention will now be described with reference to the accompanying drawings. FIG. 1 is an exploded view of a stabilizer bush 10 according to a first embodiment of the present invention. As shown in FIG. 1, the stabilizer bush 10 includes a first elastic body 20, a second elastic body 30, and a bracket 50. The first and second elastic bodies 20, 30 surround the outer periphery of a stabilizer bar 11. The bracket 50 fastens the first and second elastic bodies 20, 30 to a vehicle body (not shown).

The first elastic body 20 is a semi-cylindrical rubber elastic body. A flange portion 22 is connected to the first elastic body 20. The flange portion 22 communicates with an axial end face 21. The peripheral edge of the flange portion 22 protrudes in the radial direction. The second elastic body 30 is a semi-cylindrical rubber elastic body. A flange portion 32 is connected to the second elastic body 30. The flange portion 32 communicates with an axial end face 31. The peripheral edge of the flange portion 32 protrudes in the radial direction.

A semi-cylindrical reinforcing plate 40 is embedded in the first and second elastic bodies 20, 30. The reinforcing plate 40 is a member having a higher rigidity than the first and second elastic bodies 20, 30. In the first embodiment, the reinforcing plate 40 is formed of a metal material. The reinforcing plate 40 is disposed along the entire axial length of the first and second elastic bodies 20, 30. The end portion of the reinforcing plate 40 is exposed from the end faces 21, 31 of the first and second elastic bodies 20, 30.

The bracket 50 is a metal member having a U-shaped cross-section, and disposed on the outer periphery between the flange portions 22, 32 of the first and second elastic bodies 20, 30. The bracket 50 is mounted on the vehicle body (not shown) by using fixing portions 51. The fixing portions 51 protrude in opposing directions from the end portions of the bracket 50. The bracket 50 fastens the stabilizer bar 11 to the vehicle body through the first and second elastic bodies 20, 30.

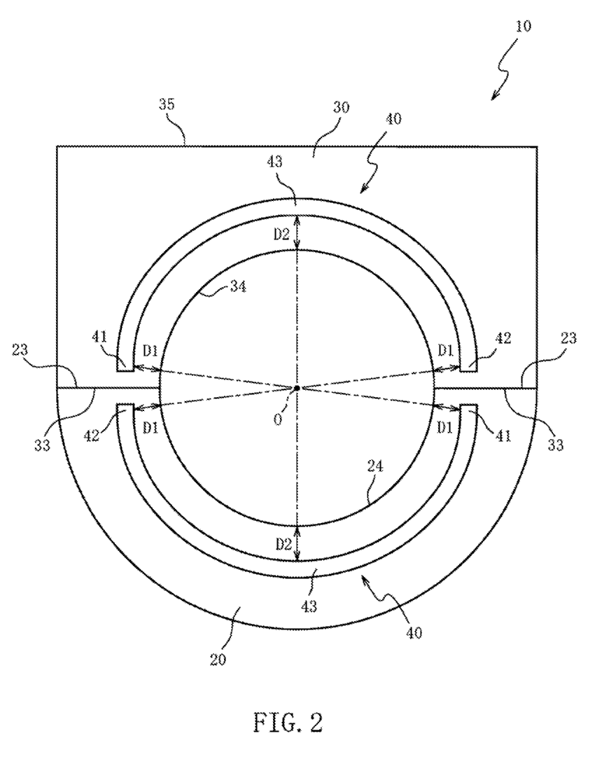

FIG. 2 is a front view illustrating the first elastic body 20 and the second elastic body 30. The first elastic body 20 is a semi-cylindrical member, and forms an inner surface 24 that is a set of arcs around an axis 0 of the stabilizer bar 11 (see FIG. 1). The second elastic body 30 is a member that is substantially U-shaped. The second elastic body 30 has a flat mounting surface 35 that is to be pressed against the vehicle body (not shown), and forms an inner surface 34 that is a set of arcs around the axis 0 of the stabilizer bar 11 (see FIG. 1). The first elastic body 20 and the second elastic body 30 are disposed on the outer periphery of the stabilizer bar 11 (see FIG. 1) while their circumferential end faces 23, 33 are abutted on each other.

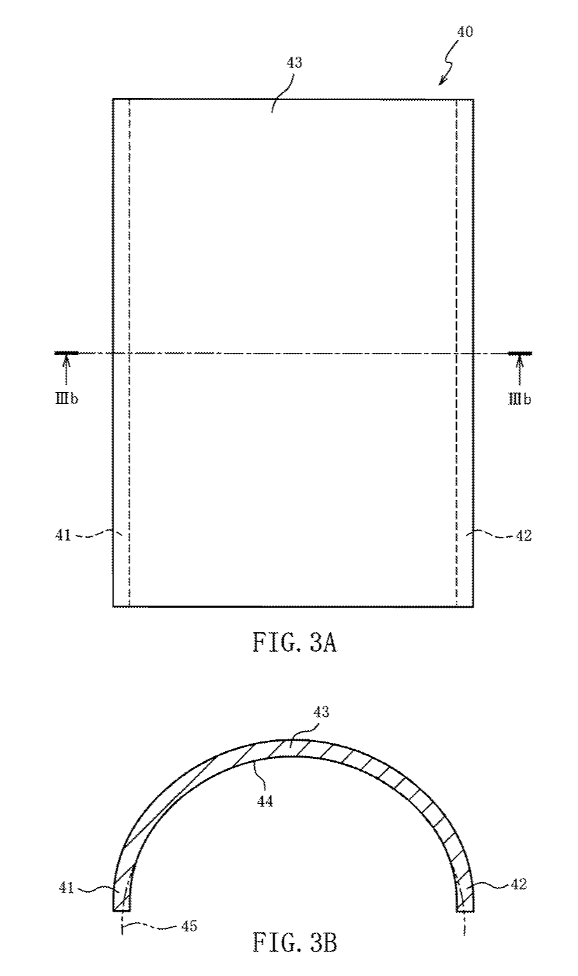

The reinforcing plate 40, which is to be vulcanization-bonded to the first and second elastic bodies 20, 30, will now be described with reference to FIGS. 3A and 3B. FIG. 3A is a plan view of the reinforcing plate 40. FIG. 3B is a cross-sectional view of the reinforcing plate 40 taken along line IIIb-IIIb of FIG. 3A.

As shown in FIGS. 3A and 3B, the reinforcing plate 40 is a semi-cylindrical member. The reinforcing plate 40 includes a first end portion 41, a second end portion 42, and an intermediate portion 43. The first end portion 41 and the second end portion 42 are linearly extended in the axial direction. The intermediate portion 43 is semi-cylindrical in shape and connected to the first and second end portions 41, 42 along the entire axial length of the first and second end portions 41, 42. A plate material for the reinforcing plate 40 is bent to form the first end portion 41, the second end portion 42, and the intermediate portion 43.

As shown in FIG. 3B, an inner surface 44 of the reinforcing plate 40 is configured so that the inner surface 44 of the intermediate portion 43 coincides with a virtual curved surface 45, which is a set of arcs around the axis 0 of the stabilizer bar 11 (see FIG. 1), and that the inner surface 44 of the first and second end portions 41, 42 exists radially inward from the virtual curved surface 45. The inner surface 44 of the intermediate portion 43 has the same curvature as the inner surfaces 24, 34 of the first and second elastic bodies 20, 30. The reinforcing plate 40 is formed by bending its plate material in such a manner that the inner surface 44 of the first and second end portions 41, 42 has a smaller curvature than the inner surface 44 of the intermediate portion 43. This makes it easy to form the first and second end portions 41, 42.

Returning to FIG. 2, further description will be given. The reinforcing plate 40 is embedded in the first and second elastic bodies 20, 30 by positioning it apart from the end faces 23, 33 and inner surfaces 24, 34 of the first and second elastic bodies 20, 30. The reinforcing plate 40 is such that its first and second end portions 41, 42 are positioned circumferentially inward from the end faces 23, 33 of the first and second elastic bodies 20, 30.

The reinforcing plate 40 is formed so that the first and second end portions 41, 42 have a smaller curvature than the intermediate portion 43. Therefore, the radial thickness D1 of the first and second elastic bodies 20, 30, which is measured between the first and second end portions 41, 42 and the inner surfaces 24, 34, can be smaller than the radial thickness D2 of the first and second elastic bodies 20, 30, which is measured between the intermediate portion 43 and the inner surface 24, 34. The thickness D1, D2 is the length of a line segment that is obtained by cutting a straight line vertically crossing the axis 0 with the inner surface 44 of the reinforcing plate 40 (see FIG. 3B) and with the inner surfaces 24, 34 of the first and second elastic bodies 20, 30.

For example, the following method is used to adhere the first elastic body 20 and the second elastic body 30 to the stabilizer bar 11. First of all, an adhesive (not shown) is applied between the inner surfaces 24, 34 of the first and second elastic bodies 20, 30 and the outer periphery of the stabilizer bar 11. Next, the first and second elastic bodies 20, 30 are surrounded by a clamp (not shown) placed on the radial outside. The clamp is then used to press the inner surfaces 24, 34 against the stabilizer bar 11. The adhesive, the first elastic body 20, and the second elastic body 30 are high-frequency heated through the stabilizer bar 11. Eventually, the adhesive cures to adhere the first and second elastic bodies 20, 30 to the stabilizer bar 11.

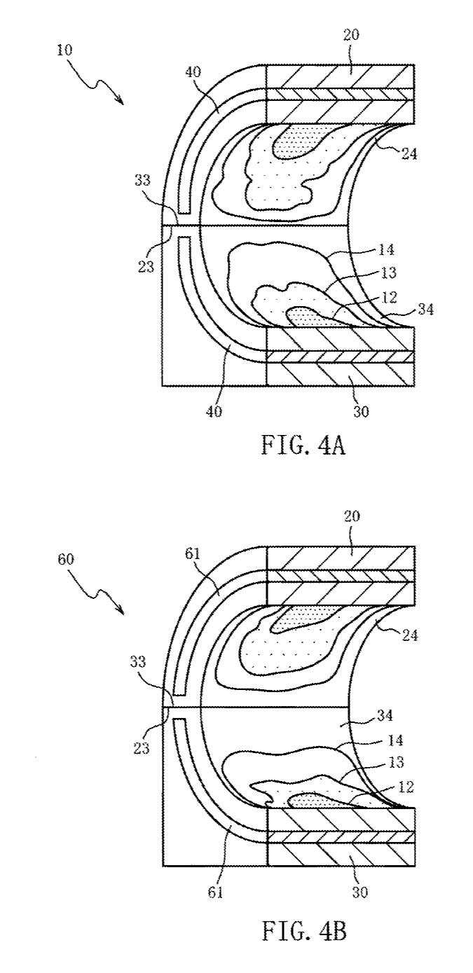

FIG. 4A is a schematic diagram illustrating the pressure distribution of the stabilizer bush 10 that is obtained when pressurization is performed to press the inner surfaces 24, 34 against the stabilizer bar 11 for the purpose of curing the adhesive. FIG. 4B is a schematic diagram illustrating the pressure distribution of a stabilizer bush 60 in a comparative example in which pressurization is performed under the same conditions as FIG. 4A. FIGS. 4A and 4B each illustrate the result of computer-based simulation on half the circumference of the first and second elastic bodies 20, 30.

The stabilizer bush 60 in the comparative example is formed so that a reinforcing plate 61 is embedded in the first and second elastic bodies 20, 30. The stabilizer bush 60 is similar to the stabilizer bush 10 except that the reinforcing plate 61 has a different shape from the reinforcing plate 40. The reinforcing plate 61 differs from the reinforcing plate 40 in that the curvature remains constant along the entire circumferential length. The reinforcing plate 40 is configured so that the first and second end portions 41, 42 have a different curvature from the intermediate portion 43.

When the inner surfaces 24, 34 of the first and second elastic bodies 20, 30 are pressed against the stabilizer bar 11, the inner surfaces 24, 34 receive pressure from the stabilizer bar 11. Curves 12, 13, 14 marked on the inner surfaces 24, 34 of the first and second elastic bodies 20, 30 are obtained by connecting portions placed under the same pressure. The order of increasing pressure is the curve 14, the curve 13, and the curve 12. A portion outside of the curve 14 is lower in pressure than a portion enclosed by the curve 14.

As is obvious from FIG. 4B, the pressure applied from the stabilizer bar 11 to the first and second elastic bodies 20, 30 for adhesion purposes is highest at the circumferential center and decreases with a decrease in the distance to the end faces 23, 33. The reason is that the reinforcing plate 61 does not exist in the vicinity of the end faces 23, 33 of the first and second elastic bodies 20, 30. As a result, the vicinity of the end faces 23, 33 of the first and second elastic bodies 20, 30 has lower adhesion strength than the vicinity of the circumferential center. This causes a problem where the vicinity of the end faces 23, 33 of the first and second elastic bodies 20, 30 is likely to peel off due to repeated load input from the stabilizer bar 11 to the first and second elastic bodies 20, 30.

Meanwhile, a comparison between the stabilizer bush 10 and the stabilizer bush 60 in the comparative example shows that the stabilizer bush 10 brings the curves 13, 14 closer to the end faces 23, 33 and reduces the area of a portion (a portion outside of the curve 14) that is lower in pressure than a portion enclosed by the curve 14. The reason is that the radial thickness D1 of the first and second elastic bodies 20, 30, which is measured between the first end portion 41 of the reinforcing plate 40 (see FIG. 2) and the inner surfaces 24, 34 of the first and second elastic bodies 20, 30 and the radial thickness D1 of the first and second elastic bodies 20, 30, which is measured between the second end portion 42 of the reinforcing plate 40 and the inner surfaces 24, 34 of the first and second elastic bodies 20, 30 are smaller than the radial thickness D2 of the first and second elastic bodies 20, 30, which is measured between the intermediate portion 43 of the reinforcing plate 40 and the inner surfaces 24, 34 of the first and second elastic bodies 20, 30.

The above decreases the difference between the pressure applied for adhesion purposes from the stabilizer bar 11 (see FIG. 1) to the first and second elastic bodies 20, 30 in the vicinity of the first and second end portions 41, 42 of the reinforcing plate 40 and the pressure applied for adhesion purposes from the stabilizer bar 11 to the first and second elastic bodies 20, 30 in the vicinity of the intermediate portion 43 of the reinforcing plate 40. This reduces the area of a low-pressure portion existing in the vicinity of the end faces 23, 33 of the first and second elastic bodies 20, 30. Therefore, the area of a portion having low adhesion strength is reduced. Consequently, the vicinity of the end faces 23, 33 of the first and second elastic bodies 20, 30 is unlikely to peel off even when repeated load is inputted from the stabilizer bar 11 to the first and second elastic bodies 20, 30. This improves the durability of the stabilizer bush 10.

The reinforcing plate 40 is vulcanization-bonded to the entire axial length of the first and second elastic bodies 20, 30. Therefore, the pressure is properly applied to the inner surfaces 24, 34 along the entire axial length of the first and second elastic bodies 20, 30. As a result, adequate adhesion strength is obtained along the entire axial length of the first and second elastic bodies 20, 30.

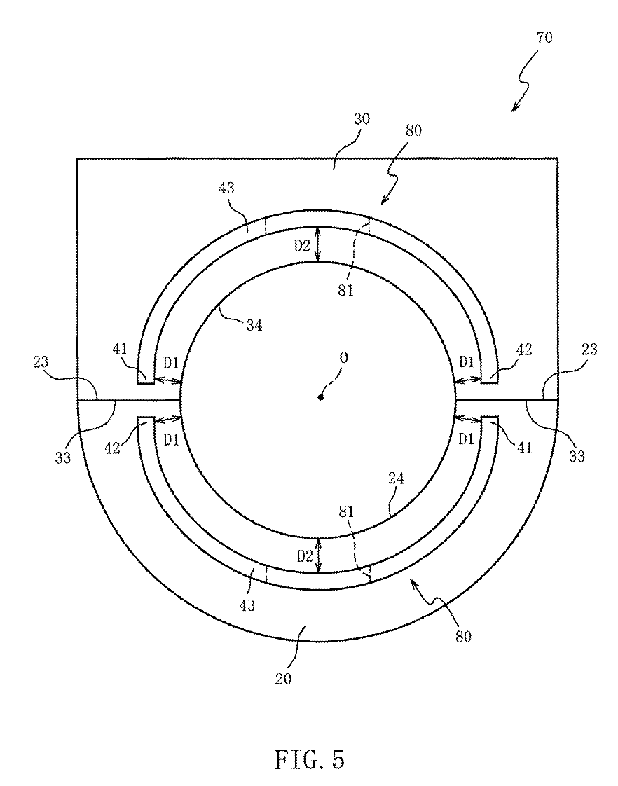

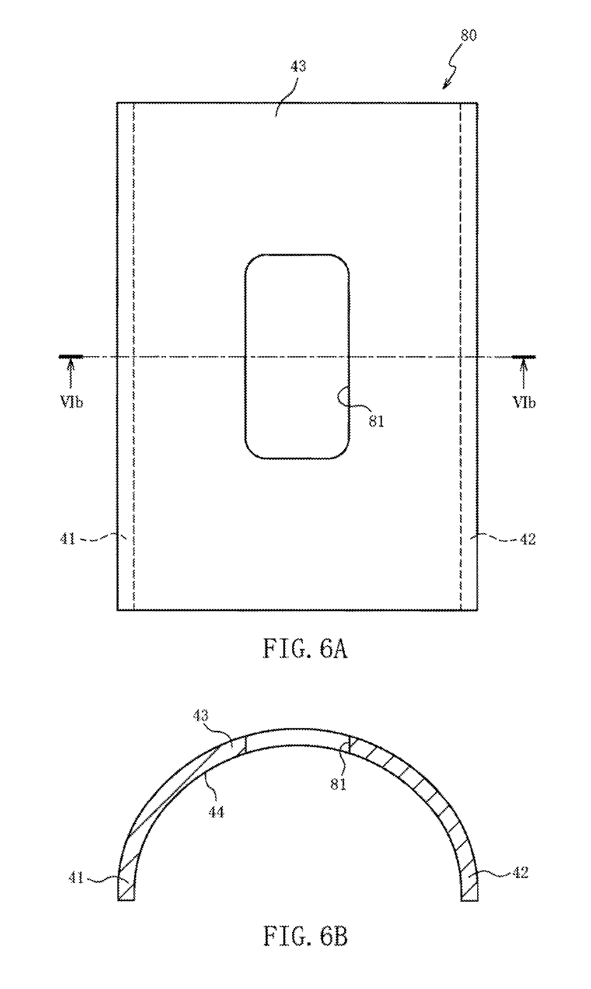

A second embodiment of the present invention will now be described with reference to FIGS. 5, 6A, and 6B. Elements identical with those described in conjunction with the first embodiment are designated by the same reference numerals and will not be redundantly described. FIG. 5 is a front view illustrating the first and second elastic bodies 20, 30 of a stabilizer bush 70 according to the second embodiment. FIG. 6A is a plan view of a reinforcing plate 80. FIG. 6B is a cross-sectional view of the reinforcing plate 80 taken along line VIb-VIb of FIG. 6A. The first and second elastic bodies 20, 30 according to the second embodiment are fastened to the vehicle body (not shown) by using the bracket 50 (see FIG. 1) as is the case with the first and second elastic bodies 20, 30 described in conjunction with the first embodiment.

As shown in FIG. 5, the stabilizer bush 70 is disposed on the outer periphery of the stabilizer bar 11 (see FIG. 1) while the circumferential end faces 23, 33 of the first and second elastic bodies 20, 30 are abutted on each other. The reinforcing plate 80 is embedded in the first and second elastic bodies 20, 30. The reinforcing plate 80 is formed of a metal material and vulcanization-bonded to the first and second elastic bodies 20, 30.

As shown in FIGS. 6A and 6B, the reinforcing plate 80 is configured so that a hole 81 is formed in the radial direction through the circumferential center of the semi-cylindrical intermediate portion 43 that connects the first end portion 41 to the second end portion 42. In the second embodiment, the hole 81 is rectangular in shape, longer in the axial direction than in the circumferential direction, and formed to penetrate through the axial center of the intermediate portion 43.

Returning to FIG. 5, further description will be given. The reinforcing plate 80 is positioned radially outward from the inner surfaces 24, 34 of the first and second elastic bodies 20, 30, and the first end portion 41 and the second end portion 42 are positioned circumferentially inward from the end faces 23, 33 of the first and second elastic bodies 20, 30. The radial thickness D1 of the first and second elastic bodies 20, 30, which is measured between the first and second end portions 41, 42 of the reinforcing plate 80 and the inner surfaces 24, 34, is smaller than the radial thickness D2 of the first and second elastic bodies 20, 30, which is measured between the intermediate portion 43 and the inner surfaces 24, 34.

The above decreases the difference between the pressure applied for adhesion purposes from the stabilizer bar 11 (see FIG. 1) to the first and second elastic bodies 20, 30 in the vicinity of the first and second end portions 41, 42 of the reinforcing plate 80 and the pressure applied for adhesion purposes from the stabilizer bar 11 to the first and second elastic bodies 20, 30 in the vicinity of the intermediate portion 43 of the reinforcing plate 80.

Further, the hole 81 formed in the intermediate portion 43 reduces the pressure applied for adhesion purposes to the circumferential center of the first and second elastic bodies 20, 30 (a portion enclosed by the curve 12 shown in FIG. 4A). This decreases the difference between the pressure applied from the stabilizer bar 11 (see FIG. 1) to the circumferential center of the first and second elastic bodies 20, 30 and the pressure applied from the stabilizer bar 11 to the vicinity of the circumferential end faces 23, 33 of the first and second elastic bodies 20, 30. The above reduces circumferential pressure variations when the first and second elastic bodies 20, 30 are pressurized for adhesion purposes. Consequently, circumferential variations in the adhesion strength of the first and second elastic bodies 20, 30 can be reduced.

If the adhesion strength of the first and second elastic bodies 20, 30 significantly varies, a problem may arise because a portion having low adhesion strength is likely to peel off due to repeated load input from the stabilizer bar 11. This problem can be addressed by the stabilizer bush 70, which is configured so that the hole 81 is formed in the reinforcing plate 80. Therefore, in addition to the advantageous effect described in conjunction of the first embodiment, adhesion strength variations in the circumferential direction of the first and second elastic bodies 20, 30 can be suppressed.

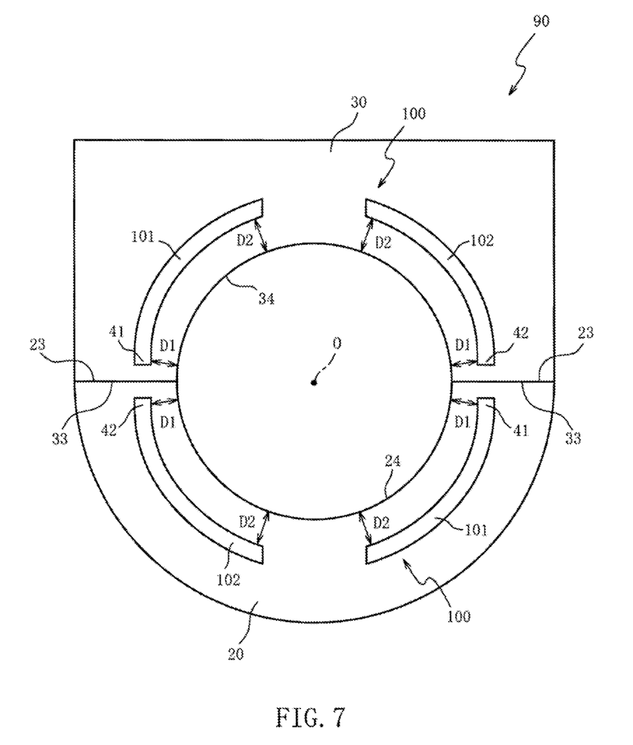

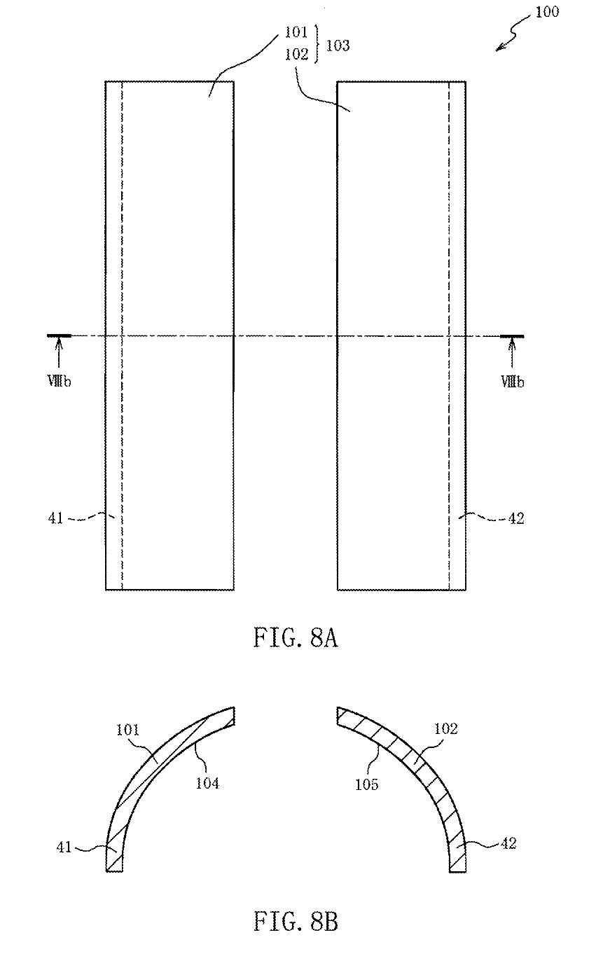

A third embodiment of the present invention will now be described with reference to FIGS. 7, 8A, and 8B. The second embodiment has been described on the assumption that the hole 81 is formed in the reinforcing plate 80. Meanwhile, the third embodiment will be described on the assumption that a reinforcing plate 100 is divided into two portions. Elements identical with those described in conjunction with the first embodiment are designated by the same reference numerals and will not be redundantly described.

FIG. 7 is a front view illustrating the first and second elastic bodies 20, 30 of a stabilizer bush 90 according to the third embodiment. FIG. 8A is a plan view of the reinforcing plate 100. FIG. 8B is a cross-sectional view of the reinforcing plate 100 taken along line VIIIb-VIIIb of FIG. 8A. The first and second elastic bodies 20, 30 according to the third embodiment are fastened to the vehicle body (not shown) by using the bracket 50 (see FIG. 1) as is the case with the first and second elastic bodies 20, 30 described in conjunction with the first embodiment.

As shown in FIG. 7, the stabilizer bush 90 is disposed on the outer periphery of the stabilizer bar 11 (see FIG. 1) while the circumferential end faces 23, 33 of the first and second elastic bodies 20, 30 are abutted on each other. The reinforcing plate 100 is embedded in the first and second elastic bodies 20, 30. The reinforcing plate 100 is formed of a metal material and vulcanization-bonded to the first and second elastic bodies 20, 30.

As shown in FIGS. 8A and 8B, the reinforcing plate 100 includes an intermediate portion 103 that is connected to the first end portion 41 and to the second end portion 42. The intermediate portion 103 includes a first portion 101 and a second portion 102. The first portion 101 is connected to the first end portion 41 along its entire axial length. The second portion 102 is connected to the second end portion 42 along its entire axial length. The first portion 101 and the second portion 102 are separate from each other, and respectively include inner surfaces 104, 105, which are curved in a concave manner.

Returning to FIG. 7, further description will be given. The reinforcing plate 100 is configured so that the first portion 101 and the second portion 102 are spaced apart from each other in the circumferential direction of the first and second elastic bodies 20, 30 and disposed except at the circumferential center of the first and second elastic bodies 20, 30. The first portion 101 and the second portion 102 are vulcanization-bonded to the first and second elastic bodies 20, 30 and spaced apart from each other uniformly over the entire axial length.

The reinforcing plate 100 is positioned radially outward from the inner surfaces 24, 34 of the first and second elastic bodies 20, 30, and the first end portion 41 and the second end portion 42 are positioned circumferentially inward from the end faces 23, 33 of the first and second elastic bodies 20, 30. The radial thickness D1 of the first and second elastic bodies 20, 30, which is measured between the first and second end portions 41, 42 of the reinforcing plate 100 and the inner surfaces 24, 34, is smaller than the radial thickness D2 of the first and second elastic bodies 20, 30, which is measured between the inner surfaces 104, 105 (see FIG. 8B) of the first and second portions 101, 102 and the inner surfaces 24, 34.

The above decreases the difference between the pressure applied for adhesion purposes from the stabilizer bar 11 (see FIG. 1) to the first and second elastic bodies 20, 30 in the vicinity of the first and second end portions 41, 42 of the reinforcing plate 100 and the pressure applied for adhesion purposes from the stabilizer bar 11 to the first and second elastic bodies 20, 30 in the vicinity of the first and second portions 101, 102 of the reinforcing plate 100.

Further, the circumferential space between the first and second portions 101, 102 reduces the pressure applied for adhesion purposes to the circumferential center of the first and second elastic bodies 20, 30 (a portion enclosed by the curve 12 shown in FIG. 4A). This decreases the difference between the pressure applied from the stabilizer bar 11 (see FIG. 1) to the circumferential center of the first and second elastic bodies 20, 30 and the pressure applied from the stabilizer bar 11 to the vicinity of the circumferential end faces 23, 33 of the first and second elastic bodies 20, 30. The above reduces circumferential pressure variations when the first and second elastic bodies 20, 30 are pressurized for adhesion purposes. Consequently, circumferential variations in the adhesion strength can be reduced. As the first portion 101 and the second portion 102 are disposed apart from each other, the stabilizer bush 90 not only provides the advantageous effect described in conjunction of the first embodiment, but also suppresses adhesion strength variations in the circumferential direction of the first and second elastic bodies 20, 30.

While the present invention has been described with reference to the foregoing embodiments, the present invention is not limited to the foregoing embodiments. It is readily understood that various improvements and modifications may be made without departing from the spirit and scope of the present invention. For example, the shape and size of the hole 81 in the reinforcing plate 80 may be set as appropriate. In addition to the hole 81, an additional hole may be formed at a desired position as needed to adjust the pressure applied for adhesion purposes.

The foregoing embodiments have been described on the assumption that the bracket 50 having a U-shaped cross-section is used to fasten the first and second elastic bodies 20, 30 to the vehicle (not shown). However, the present invention is not limited to such a configuration. Obviously, the present invention may alternatively use a well-known bracket that includes a pair of members having respective concave portions engaging with the outer periphery of the first and second elastic bodies 20, 30. This bracket is fastened to the vehicle body while the first and second elastic bodies 20, 30 are sandwiched between the pair of members.

The foregoing embodiments have been described on the assumption that the reinforcing plate 40, 80, 100 is formed of a metal material. However, the present invention is not limited to such a reinforcing plate. It is obvious that the reinforcing plate 40, 80, 100 formed of synthetic resin may alternatively be used. The reason is that the pressure applied for adhesion purposes can be increased as far as the reinforcing plate 40, 80, 100 has a higher rigidity than the first and second elastic bodies 20, 30.

The foregoing embodiments have been described on the assumption that the axial end face of the reinforcing plate 40, 80, 100 is exposed from the axial end faces 21, 31 of the first and second elastic bodies 20, 30. However, the present invention is not limited to such a configuration. Obviously, the reinforcing plate 40, 80, 100 may be embedded in the axial end faces 21, 31 of the first and second elastic bodies 20, 30 in order not to expose the reinforcing plate 40, 80, 100 from the axial end faces 21, 31 of the first and second elastic bodies 20, 30.

The foregoing embodiments have been described on the assumption that the first and second end portions 41, 42 of the reinforcing plate 40, 80, 100 are formed by bending a plate material at different curvatures. However, the present invention is not limited to such a method. Obviously, the thickness D1 may be made smaller than the thickness D2 by using the first and second end portions 41, 42 that are thicker than the intermediate portion 43, 103. Even when such an alternative scheme is used, it is possible to increase the pressure applied to the inner surfaces 24, 34 in the vicinity of the circumferential end faces 23, 33 of the first and second elastic bodies 20, 30, as is the case with the foregoing embodiments.

The second embodiment has been described on the assumption that the hole 81 is formed in the thickness direction to penetrate through the axial center of the intermediate portion 43 of the reinforcing plate 80. However, the present invention is not limited to such a hole. Obviously, a cut extended from the center of an axial edge to the axial center may be made in the intermediate portion 43 of the reinforcing plate 80 and used as the hole. The hole formed by the cut also penetrates in the radial direction, as is the case with the hole 81 acting as a through-hole. Therefore, the cut decreases the pressure exerted by the reinforcing plate 80 (intermediate portion 43). For example, the axial length and circumferential width of the cuts acting as the hole and the number of cuts may be set as appropriate.

The third embodiment has been described on the assumption that the reinforcing plate 100 is divided into two portions. However, the present invention is not limited to such a scheme. The reinforcing plate 100 may be divided into three or more portions as needed to adjust the pressure applied for adhesion purposes.

1. A stabilizer bush comprising:
a pair of elastic bodies that are semi-cylindrical rubber elastic bodies disposed on the outer periphery of a stabilizer bar, two circumferential end faces of the elastic bodies being abutted on each other, the stabilizer bar adhering to the inner surfaces of the elastic bodies; and
a reinforcing plate that is higher in rigidity than the elastic bodies and embedded in each of the elastic bodies;
wherein the reinforcing plate includes
a first end portion and a second end portion that are disposed circumferentially inward from the circumferential end faces of the elastic bodies, and
an intermediate portion that is connected to the first end portion and to the second end portion,
wherein the radial thickness of the elastic bodies measured between the first end portion and the inner surfaces and the radial thickness of the elastic bodies measured between the second end portion and the inner surfaces are smaller than the radial thickness of the elastic bodies measured between the intermediate portion and the inner surfaces.

2. The stabilizer bush according to claim 1, wherein the reinforcing plate is formed into a semi-cylindrical shape, and configured so that the inner surfaces of the first and second end portions have a smaller curvature than the inner surface of the intermediate portion.

3. The stabilizer bush according to claim 1, wherein the reinforcing plate is formed into a semi-cylindrical shape, and configured so that a hole is formed in the radial direction at least through the circumferential center of the elastic bodies.

4. The stabilizer bush according to claim 1, wherein the intermediate portion includes a first portion and a second portion, the first portion being connected to the first end portion, the second portion being connected to the second end portion; and wherein the first portion and the second portion are spaced circumferentially apart from each other and disposed except at the circumferential center of the elastic bodies.
